(19) United States
(12) Patent Application Publication
(10) Pub. No.: US 2007/0021073 A1
(43) Pub. Date: Jan. 25, 2007

(54) Modular personal audio device

(76) Inventor: Pat Sean Gratton, Dallas, TX (US)

Correspondence Address: PAT SEAN GRATTON, 5530 WENONAH, DALLAS, TX, 75209, US

(21) Appl. No.: 10/569,704

(22) PCT Filed: Aug. 24, 2004
(86) PCT No.: PCT/US04/27400

§ 371 Date: Sep. 26, 2006

Related U.S. Application Data
(60) Provisional application No. 60/497,635, filed on Aug. 25, 2003.

(51) Int. Cl. H04B 1/38

(52) U.S. Cl. 455/90.2

(57) ABSTRACT

A modularization system for personal audio devices. The personal audio device is divided into four required modules: 1) a mount (101), 2) an audio core (102), an audio IO set (103), and a remote control (104). Auxiliary modules (105) (e.g., a battery module, a memory module) are also available, but not required.

### 1 FIELD OF INVENTION

This invention relates to personal audio devices, e.g., to mobile telephones, personal music players, voice recorders, etc. More specifically, it relates to how these devices are integrated, carried, made wearable and used in off-person configurations.

### 2 BRIEF DESCRIPTION OF DRAWINGS

FIG. 11: Mopad System.

A diagram of MOPADs components and the relationships between them.

101: Mount

102: Audio Core

103: Audio IO Set

104: Remote Control

105: Auxiliary Module

FIG. 12: Audio Core

A diagram of the audiocore components and connections.

106: Audio Core Power Source

107: Audio Core PAA Electronics

108: Audio Core Local Wireless Electronics

109: Audio Core On/Off/Standby Switch

110: Audio Core Electrical Connector

FIG. 13: Audio Core

Another view of the audiocore module, focussing on electrical and mechanical connections.

110: Audio Core Electrical Connector

111: Audio Core Slots

FIG. 14: Mount

A diagram of the mount showing the electrical and mechanical connections.

101: Mount

112: Receptacle

113: Receptacle Rails

114: Receptacle Electrical Connector

115: Receptacle Locking Mechanism

FIG. 15: Mount

A diagram of the mount, showing internal components and the relationships between them.

101: Mount

103: Audio IO

105: Auxiliary Module

112: Receptacle

116: Internal Wiring

FIG. 16: Mount

A diagram of an alternative configuration of the mount, showing its internal components and relationship with external (wire connected) components.

101: Mount

103: Audio IO

105: Auxiliary Module

112: Receptacle

116: Internal Wiring

117: External Audio IO Connector

118: External Auxiliary Module Connector

FIG. 17: Local Wireless Connections

A diagram of local wireless connections between MOPAD components.

102: Audio Core

103: Audio IO Set

104: Remote Control

105: Auxiliary Module

FIG. 18: Pocket Remote

A typical pocket sized remote control.

119: Keypad

120: Display

FIG. 19: Pocket Remote Displays

Pocket remote with various typical displays.

FIG. 20: Wrist Remote

A wrist remote with display and controls.

121: Peripheral Buttons

122: Bezel Ring Control

123: Display

FIG. 21: Wrist Remote Displays

Wrist remote with various typical displays.

FIG. 22: Audio IO Set

An audio IO set with components.

124: Microphone

125: Monophonic or Stereophonic Output

FIG. 23: Necklace Mount

A necklace mount with components.

105: Auxiliary Module

112: Receptacle

116: Internal Wiring

124: Microphone

125: Earphones

126: Clasp

127: Faceplate

FIG. 24: Necklace Mount

Detail view of one implementation of the necklace mount showing clasp and earpiece connectors and spooling mechanism.

125: Earphones

126: Clasp

128: Spool

FIG. 25: String Tie Mount

String tie mount and components.

105: Auxiliary Module

112: Receptacle

124: Microphone

125: Earphones

127: Faceplate

129: String

130: Crosspiece

FIG. 26: String Tie Mount

Back view of crosspiece of string-tie mount showing electrical connection between crosspiece and string.

129: String

130: Crosspiece

131: Loop Connector

FIG. 27: String Tie Mount

Back view of crosspiece of string-tie mount showing alternative implementation of electrical connection between crosspiece and string.

129: String

130: Crosspiece

132: Spool Connector

FIG. 28: Scarf Mount

Scarf variation of string tie mount.

130: Crosspiece

133: Scarf

FIG. 29: Necktie Mount

Necktie variation of string tie mount.

130: Crosspiece

134: Necktie Swath Slot

135: Necktie Swath

FIG. 30: Necklace Audio IO Set

Much the same as the necklace mount, but without the mount.

116: Internal Wiring

124: Microphone

125: Earphones

126: Clasp

127: Faceplate

136: Wireless Receiver

FIG. 31: String Tie Audio IO Set

Much the same as the string tie mount, but without the mount.

124: Microphone

125: Earphones

127: Faceplate

129: String

130: Crosspiece

136: Wireless Receiver

FIG. 32: Slip Mount

Isolated mount designed to be slipped into various items of attire (bra, vest, etc.)

105: Auxiliary Module

112: Receptacle

116: Internal Wiring

117: External Audio IO Connector

118: External Auxiliary Module Connector

FIG. 33: Shoulder Fore Mount

Vest type mount with mount at front.

112: Receptacle

137: Shoulder Loops

138: Back Strap

139: Front Strap

FIG. 34: Shoulder Rear Mount

Vest type mount with mount at rear.

112: Receptacle

FIG. 35: Armband Mount

Armband mount with components and electrical connection to earphones or headset.

112: Receptacle

140: Armband

FIG. 36: Bra Center Mount

Mount integrated into center of bra.

112: Receptacle

FIG. 37: Belt Mount

Mount to be worn on belt.

112: Receptacle

FIG. 38: Bag Mount

Mount for a backpack or other carried bag.

112: Receptacle

FIG. 39: Handset Mount

Handset mount with components and receptacle.

112: Receptacle

119: Keypad

120: Display

124: Microphone

125: Speaker

FIG. 40: Stationary Mount

Stationary mount with components. Show in a speaker phone configuration.

112: Receptacle

119: Keypad

120: Display

124: Microphone

125: Speaker

141: Handset

FIG. 41: Stationary Mount in Vehicle

Stationary mount for vehicle. Integrated into or taking the place of the car stereo system display and controls.

112: Receptacle

119: Keypad

120: Display

### 3 Background: Introduction

Personal audio devices (PADs) are mobile audio devices that are carried on or kept near the user's person. Examples of PADs include: mobile telephones, cordless phones, personal AM/FM radio players, personal cassette players, personal CD players, personal digital music players.
Note: It is sometimes useful to talk about the personal audio applications (PAAs) supported by a PAD, rather than the PAD itself. Examples of PAAs include: mobile telephony, cordless telephony, broadcast audio reception, recorded audio playback.

While the requirements for PADs will vary somewhat depending on the PAA(s) that they support, some requirements are fairly consistent across different PAAs. These general requirements include: 1) minimal encumbrance, 2) maximal availability, and 3) stylistic adaptability.
Minimal Encumbrance: 1) The device should be easy to carry, both while in-use and not in-use. The device should be: small, light weight, and easily transferred between different user stances (sitting, standing, walking, running, driving) and different user situations (work, recreation, exercise, socializing). 2) The device should cause minimal manual and visual encumbrance. It should not occupy the user's hands or block the user's vision any more or for any longer than is necessary to provide good control of its functionality. 3) The device should cause minimal auditory encumbrance. It should not block ambient sound any more or for any longer than the user desires.
Maximal Availability: 1) The device should offer minimal encumbrance as described above so that the user is more able and willing to carry it for longer periods of time and in different situations. 2) The device should be quick and easy to access. (E.g., A wristwatch is easier and quicker to access, and hence more available, than a pocket watch.) 3) The device should have sufficient energy (e.g., battery capacity) to support its operation for an acceptable length of time.
Stylistic Adaptability: 1) The device should be stylistically attractive. 2) The device should project the image that the user wishes to have projected about theirself. (Note that any object that is intimately associated with a person (clothing, jewelry, automobile) is taken by other people to express the person's character. PADs fall into this class of intimately associated objects, and accordingly should be made to project their users' personal style and image.)

Integrated PADs support more than one PAA, thus providing: 1) reduced cumulative weight and bulk, 2) reduced complexity (one set of controls, one display, one audio IO set), and 3) application coordination (e.g., music play automatically pauses during phone conversation).

Requirements for integrated PADs are agglomerations of the requirements for the PAAs that they support. For the general requirements listed above, this amounts to “the same, only more so.”
Minimal encumbrance requirements tend to agglomerate by greatest common denominator. Example: Continual hands-free operation is more important for music players than it is for mobile telephones. But for a PAD that provides both music playback and mobile telephony, hands-free operation is as important as it is for a music playing-only PAD.
Maximal availability requirements tend to agglomerate, making the whole greater than any single part. Example: A particular user might wish to carry: a mobile telephone 50% of the time, a cordless telephone 20% of the time, and a music player 30% of the time. But because desired usage times would not entirely overlap, the same user would wish to carry an integrated PAD (supporting all of these functions) for more time that they would wish to carry any single-PAA PAD. I.e., they might wish to carry the integrated PAD 80% of the time.
Stylistic adaptability requirements tend to agglomerate like maximal availability requirements, since stylistic considerations are directly proportional to the period of the time the user carries the device.

### 4 BACKGROUND: CURRENT WEARABLE PADS

It is commonly recognized that several of the requirements for PADs can be met by making the device wearable in some way. Many attempts at wearable PADs have been made and some of these attempts have achieved notable market success. However, current solutions still suffer from substantial limitations.

Clothing PADs: The simplest approach to PAD wearability is to place the PAD in or on the user's clothing. Often this means simply placing the PAD in the user's pocket, but it may mean clipping the PAD to the user's belt, or placing it in a purse, backpack or fanny-pack worn by the user. This placement provides easy storage, but has the limitation of requiring the user to pull the device out and handle it in order to access controls, display and/or audio IO. This placement is also limited in that it requires clothing which can serve to hold the PAD. This requirement is not well met under certain circumstances—e.g., for a woman wearing an evening gown.
Wired Earphones and Headphones: For a clothing PAD, hands-free audio operation can be achieved through the use of wired earphones or headphones. These audio IO devices allow prolonged use of the PAD, but have several notable limitations: 1) The wires are unwieldy. They interfere with the user's movements. They are awkward and slow to put in place and remove. They are awkward to relocate when the user changes clothing. 2) The wires are unattractive. They cannot be easily or comfortably run under the user's clothing. On the other hand, when they are run outside of the user's clothing, they are visible and unattractive. 3) Headphones are unattractive. While earphones can be relatively subtle, headphones are too bulky to be hidden or substantially obscured.
Wireless Earphones and Headphones: Wireless earphones and headphones (typically built around Bluetooth chips and protocols) have begun to appear recently. While these are, in some ways, improvements over wired earphones and headphones, they still suffer from notable limitations. 1) Bulk and weight: Because they must carry significant power supplies and electronics, ear/headphones are bulkier and heavier than the corresponding wired versions. 2) Unattractiveness: Increased bulk makes ear/headphones more visible, and hence less attractive. 3) Sound Quality: Current Bluetooth protocols do not support high quality stereophonic sound, and so wireless ear/headphones are not suitable for music playing PAAs.
Wired Remote Controls: Some PADs that provide wired ear/headphones also provide wired remote controls. These also have notable limitations. 1) They are unwieldy and unattractive. 2) They are limited in the degree of control they provide over the operation of the PAD. (Increased control can only be achieved at the cost of increased encumbrance, since increased control requires a larger remote control.)

Armband PADs: Some music playing PADs are available in the form of a device worn on an arm band, with audio output provided through wired ear/headphones. Such devices offer a reasonable compromise of advantages and limitations for an exercising user, but tend to suffer from the problem of clothing PADs and wired earphones/headphones as discussed above, and so are not well suited for general use.

Necklace PADs: Some AM/FM radios and mobile phones are arranged to be worn around the neck like a necklace. These necklace PADs are either designed from the start to be worn as necklaces, or created by suspending a hand-held device from a strap or lanyard worn around the neck. These PADs provide hands-free audio, but are notably limited in regards to control and stylistic adaptability. 1) Control problems arise because the devices are located at a position (at or just below the neck) which makes it difficult both to see the display and manipulate the controls. 2) Stylistic adaptability problems arise from several causes. First, the devices are inherently unattractive because they are obtrusive and are visually dominated by control and display elements. Second, the devices fail to provide stylistic variation. While such lack of variation is acceptable for a wristwatch, which is peripherally placed, the same lack of variation in an object hung around the user's neck is generally unacceptable because of the centrality of the placement. (Imagine a man wearing the same necktie, or a woman wearing the same necklace every day.)
Voice Control: The problem with access to controls for necklace PADs can be partially resolved by using voice command recognition to replace manual control. While this approach has been long touted and sometimes implemented, it too has substantial limitations. 1) Technical limitations: While voice recognition has improved over the years, it still requires significant CPU, and hence power, resources—both of which are typically scare in a PAD. Moreover, current voice recognition solutions for PADs often rely on an artificial limitation of the field of possible commands. While this approach can be made to work reasonably well for telephony, it is likely to be more problematic for other PAAs. E.g., while telephony commands are relatively simple (“call Mom”), music playing commands can be more complex (“play ‘Texas Flood’ by ‘Stevie Ray Vaughn’”). 2) Lack of feedback and state information. Efficient PAD use requires that the user be provided with: a) feedback information (e.g., numbers dialed for a phone call), b) stored information (e.g., names in an address book), and c) state information (e.g., caller ID on an incoming phone call). Voice command recognition does not provide this information.

Wrist PADs: Many efforts have been made to configure PADs as wrist devices, but these efforts have suffered from several limitations: 1) technical feasibility, 2) sound quality, and 3) encumbrance. Several of these limitations are innate to the form factor of a wrist mounted device, and so will not be overcome by technical developments.
Technical Feasibility: Wearable PADs, depending on the PAAs supported, are at or beyond the limit of what can be technically achieved while still providing a solution that is acceptable to the user. I.e., it may be possible to build a mobile phone for the wrist, but the weight and bulk of the resulting device is likely to be unacceptable to the user.
Sound Quality: Wrist PADs are by their nature limited to a single speaker of limited size and power. I.e., they are monophonic devices with limited sound quality. (While earphones are of similar size, they have the advantage of being placed directly in the ear in a fixed position, and hence can (when well designed) produce high quality sound.) Thus wrist PADs are unacceptable for some PAAs, e.g. music playing.

Encumbrance: The most serious problem with wrist PADs is that of encumbrance. Wrist PADs, by their nature, cannot provide hands free operation. When a wrist PAD is in use, it must be brought to a fixed position—often near the user's ear—in order to be used. This limitation is acceptable for a wristwatch, which is typically glanced at only occasionally, for short period (on the order of a second), with the arm and wrist in a comfortable position. However, this limitation is not acceptable for PAAs, which typically require prolonged usage with arm and wrist in an uncomfortable position.

### 5 DISCLOSURE: MOPAD

Consideration of PAD requirements and review of existing PAD designs suggest that no single device is capable of meeting all demands placed on such devices. Varying user stances (sitting, driving, standing, walking) and situations (work, exercise, recreation), as well as the desire for stylistic variation, combine to require stronger adaptability and variation than can be provided by any single PAD.

On the other hand, economy and convenience both dictate that the user cannot maintain a different PAD for each occasion or day of the week. Such a multiplicity of PADs would be too expensive for many users to purchase and maintain. Moreover, the multiplicity would be too inconvenient to maintain—largely because of the difficulty of synchronizing state (e.g., settings, address book, radio address, music playlist position) across the different PADs.

However, an alternative approach is available: Mix and match of modularized PAD components. If the modularization is done well, with a well designed division of features between the components, and if well designed variations of the constituent modules are made available, then the resulting system will be readily adaptable to different user stances and situations, and will provide satisfactory stylistic variation, in a way that is both economical and convenient.

Presented here is a system, called “MOPAD” (Modular Personal Audio Device), which takes this approach.

5.1 Modularization

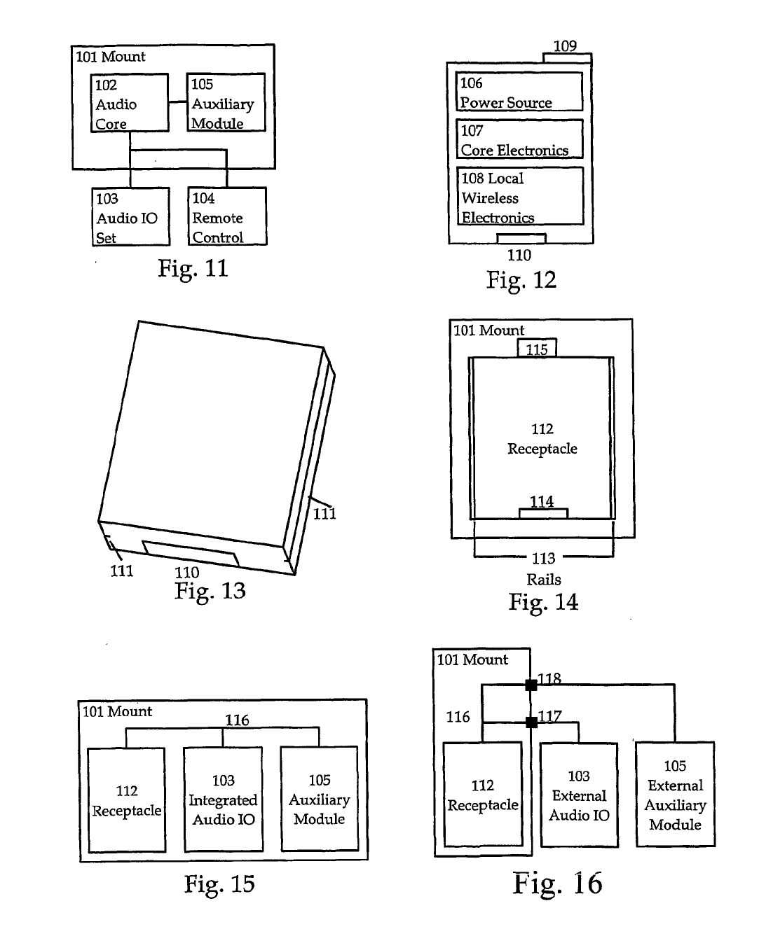

FIG. 11: MOPAD divides the PAD into four required modules: 1) a mount 101, 2) an audio core 102, 3) an audio IO set 103, and 4) a remote control 104. Auxiliary modules 105 (e.g., a battery module, a memory module) are also available, but not required.
Mount: The mount provides a setting for the audio core, and (optionally) incorporates or provides wire connections to the other modules (audio IO set, remote control, and/or auxiliary modules).
Audio Core: FIG. 12: The audio core encloses: (optionally) a power source 106, the core components 107 of the audio applications supported by the system (e.g., for mobile telephony, radio transceiver, signal processor, digital processor, etc.) and the local wireless electronic and digital components 108 (e.g., Bluetooth chips and processors). While this module does the bulk of the work of the system, it is (usually) faceless—i.e. it lacks both display and frequently used controls. Simple controls such as an on/off/standby switch 109 are provided in some embodiments. IO for the audio core is conducted through external modules (the audio IO set and the remote control) which are connected to the audio core by wire or wirelessly. Auxiliary modules, if present, are also connected to the core by wire or wirelessly.
Audio IO Set: The audio IO set provides audio input and output for the system and takes the form of earphones, headphones, or other personal audio IO device.
Remote Control: The remote control provides the manual controls and visual display for the system. Forms described below include a pocket sized device and wristwatch style device. Many additional forms are possible.
   5.2 Configuration

A complete MOPAD consists of a mount, an audio core, an audio IO set, and one or more remote controls. Adaptation and variation are achieved by switching between different versions of the various modules, and by adding or subtracting auxiliary modules.
For example: While working, a user might place the audio core in a necktie mount (with integrated audio IO), and use both a pocket and a wrist remote. Upon switching to more casual attire, the user might keep the same remotes, but move the audio core to a casually styled necklace mount. Upon switching to exercise attire, the user might discard the pocket and wrist remotes in favor of a single sports-watch style remote, and move the audio core to an arm band mount, which is connected in turn to a pair of behind the neck headphones.
Another example: The user purchases a new audio core which has greater memory, battery life, and processing power than the user's current audio core. The user would then use this audio core with their existing set of other modules (mounts, audio IO sets, remote controls).
Note: Frequent switching of audio cores is also possible. E.g., a user might switch between a telephony audio core and a music player audio core. However, it would be more desirable for the user to own a single audio core which supported multiple PAAs (mobile telephony, cordless telephony, music playing, etc.) This would prevent the loss of functionality that would accompany switching between single-PAA audio cores. Alternatively, the user can use auxiliary modules (e.g., memory, AM/FM tuner) to augment the capabilities of an audio core that does not possess broad multi-PAA support.
   5.3 Stylistic Adaptation
   Stylization of Modules:
Mount and Audio Core: Mounts are often the most visible of the modules. The mount may be rendered stylistically simple (necktie, string tie, simple necklace) or complex (intricately wrought piece of jewelry constructed of precious metals and gems). Within the mount, the audio core may be exposed, hidden within the structure of the mount, or covered by a stylized faceplate. For some mount designs, stylistic variation is achieved by switching between different versions of elements attached to the mount (e.g., by switching between different audio core faceplates, or by switching between different necktie swaths for a necktie mount). Stylization is also achieved by placing the mount under the user's clothing or in a purse, backpack or similar container, and relying on the user's clothing or the container to provide stylization.
Audio IO Set and Remote Control: Though these IO modules are generally less visible than the mount, they still benefit from stylization. Wrist remotes, earphones and headphones, are peripherally visible and are stylized to about the degree that wristwatches and earrings are stylized. Pocket remotes are visible only while in use, and are dominated by their controls and display, and so are stylized only to about the degree that handheld mobile phones are stylized.
Auxiliary modules are stylized similarly to audio cores.

Stylization by Exchange of Modules: Exchange of modules is likely to provide the greatest amount of occasion to occasion and day to day stylistic adaptation. E.g., moving the audio core from a necktie mount to one of several necklace mounts owned by the user provides substantial stylistic adaptation at relatively low cost.

5.4 Construction

Since the MOPAD is primarily a reconfiguration of existing technology, no substantial new technology is used in constructing the modules. Audio core, audio IO set, wire connections and wireless connections are all built using current technologies. (E.g., for wireless connections, Bluetooth chips and protocols are used.) (However, alternative and new technologies can also be used in the construction of MOPADs.)

Support for configuration variation is one of the key advantages of MOPADs. While the variations described above have been for devices that can be worn on the person, other variations are possible and are supported by the system. E.g., remote control, audio IO and mount can be integrated to form a handset or table-top device. These particular variations are described in later sections, but more are possible.

5.5 Operation

The exact operation of a particular MOPAD configuration depends on the nature of the mount, audio IO set, remote controls and particular PAAs running on the audio core. General operation of a MOPAD is described here, while operation details for specific modules and mounts are described in later sections.

Connection and Disconnection:

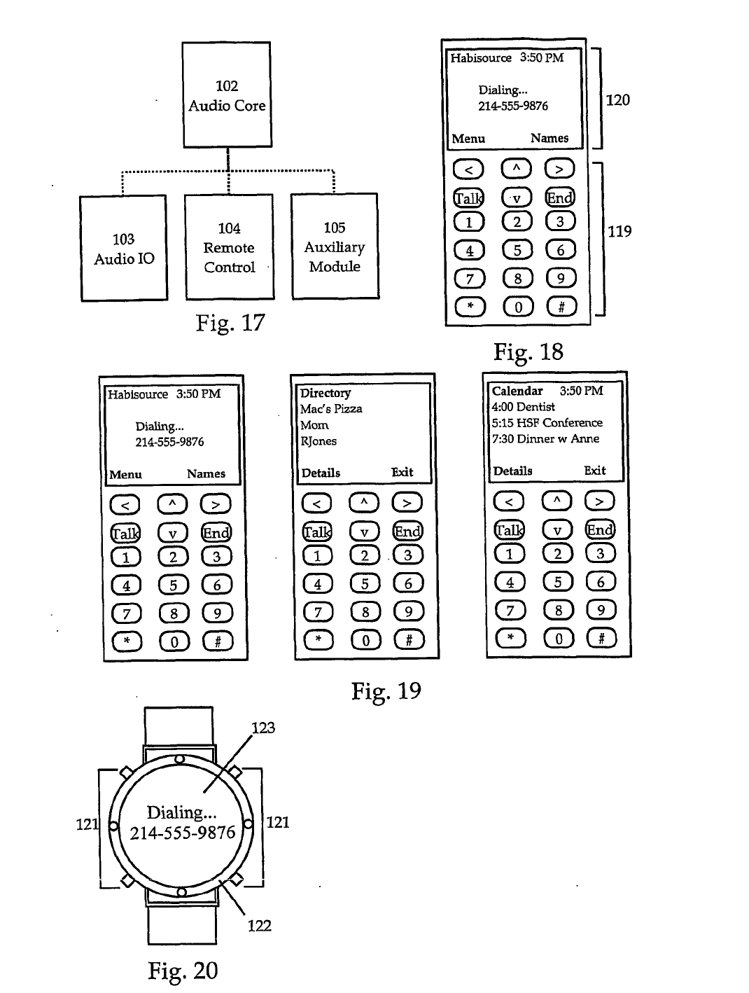

Core and Mount: Configuration of the MOPAD begins with placement of the audio core on the mount. FIG. 13: The audio core is built with standardized dimensions, with slots 111 at the edges and an electrical connector 110 at the bottom. FIG. 14: To install the audio core on the mount, the audio core is slid down into a standardized matching receptacle 112 built into the mount. The receptacle 112 has rails 113 which engage the audio core slots 111 and an electrical connector 114 at the bottom which matches the audio core electrical connector 110. When the audio core is slid fully into the receptacle 112, the electrical connectors engage, and a locking mechanism 115 clicks into place. To remove the audio core, the locking mechanism 115 is disengaged and the audio core is slid out of the receptacle 112.
FIG. 15, FIG. 16: Wire connections between the audio core and the other components are made through the mount. Some mounts provide an integrated audio IO set 103, while other mounts provide a wire connection 117 to an external audio IO set 103. Some mounts also provide a wire connection between the audio core and the remote control and/or auxiliary modules 105 (e.g., battery module, memory module). These auxiliary modules may be either integrated into the mount, or external to the mount (through a connection 118).
FIG. 17: Wireless connections between the audio core and the other modules are made through appropriate chips, and electronic and logic components built into the audio core and the external modules. A recognition and authorization protocol is used to establish the initial links between modules. After this initial connection is made, the external modules can be re-integrated into the MOPAD by being activated and brought into proximity with the audio core. For some MOPADs, an interface, presented on a remote control, is provided to manage the active wireless connections. Wireless devices are disconnected from the MOPAD by turning them off and/or moving them out of proximity with audio core.
In everyday usage, the user: selects a mount, moves the audio core to that mount, adds an audio IO set (if one is not built into the mount), and selects one or more remote controls. Modules are worn or carried as appropriate. Overall complexity of the process is similar to putting on a pair of pants.

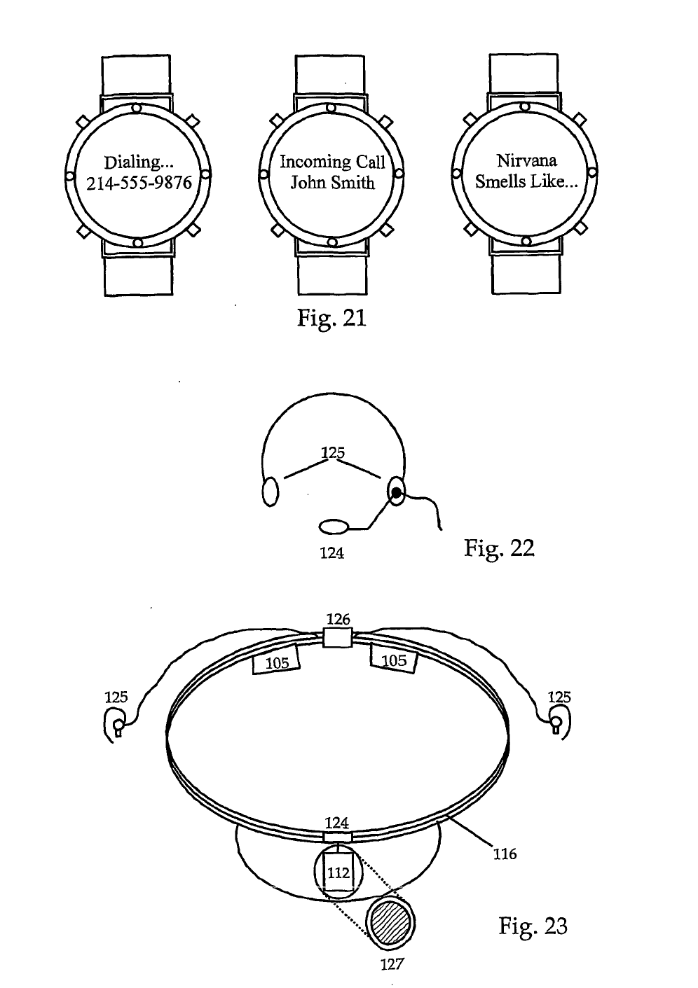

Control: The exact details of control operation depend on the nature of the remote control and the PAAs supported by the audio core. However, in essence, the user accesses whichever active remote control is most convenient and then uses its display and controls to control of the functions of the desired PAA. Three example displays for a pocket remote are shown in FIG. 19, and three example displays for a wrist remote are shown in FIG. 21.

5.6 Objects and Advantages

The object of the MOPAD is to provide the user with a PAD with high usability, convenience and economy. General advantages of the MOPAD system are described here, while advantages that are tied to particular versions of MOPAD modules are described in later sections. Note that some of the general advantages are abstract; more concrete expressions of these abstract advantages can be found in later, module version specific, sections.

Minimal Encumbrance: The different components of a PAD differ from each other in regards to preferred location to achieve minimal encumbrance. Core hardware is least encumbering when it is moved to the body, where its weight is most easily carried. Audio IO is least encumbering when it is kept hear the ears of the user. Display hardware is best suited to a position a foot or two away from and in front of the user. On the other hand, manual controls are least encumbering when put in a location that is convenient and comfortable for the hands to operate. Because MOPAD places these different components into physically distinct modules, it allows each components to be moved to its optimum location.

Different PAD components have different durations of usage. While manual and visual control usage tends to be sporadic (e.g., pausing a song, dialing a phone number), audio IO access tends to be prolonged (e.g., listening to music, engaging in a phone call). Thus, when these components are presented in a single (non-modularized) device, the prolonged usage of the audio IO component causes unnecessarily prolonged usage of the manual/visual component. MOPAD removes this tying of components (modules) and thus reduces manual and visual encumbrance. (In other words, MOPAD supports hands-free usage.)

Maximal Availability: MOPAD increases availability by: 1) encouraging the user to keep the device at-hand for longer periods and in different situations, 2) providing quick and easy access to its functions, and 3) allowing for the comfortable carriage of a sufficiently powerful and multi-functional device.
MOPAD encourages prolonged carriage in several ways: 1) By facilitating minimal encumbrance, as described above. 2) By adapting to different user activities and occasions through switching between different versions of modules. 3) By providing stylistic adaptation through: a) stylization of components, and b) movement of the audio core between stylistically varied mounts. 4) By simultaneously supporting the needs of multiple PAAs (e.g., monophonic or stereophonic output; short or long duration audio IO usage; cordless telephony or mobile telephony). In short, MOPAD provides a single solution that fits, and hence can be carried for, a wide variety of needs and occasions.
MOPAD enables quick and easy access to PAA control and display functions through wrist remotes. MOPAD also enables quick and easy access to PAA audio IO through various audio IO sets—in particular through audio IO sets integrated into necklace and string tie mounts described in later sections.
MOPAD enables comfortable carriage by moving the heaviest component of the system, the audio core, close to the body, or into an object which can be comfortably carried by the user. See specific mount descriptions in later sections.

Stylistic Adaptation: As related previously, it is important to many users that objects that are intimately associated with them (e.g., clothing, jewelry) present the image that the user wishes them to present. Furthermore, it is important that objects that are centrally located (e.g., around the chest or head) be stylistically variable. MOPAD supports such stylistic variation as described previously.

Multi-PAA Support: Users wish to use many different PAAs: mobile telephony, cordless telephony, broadcast audio reception, recorded audio playback, etc. Because MOPAD is well suited to the various demands of many different PAAs, and because it is capable of comfortably supporting the slightly greater weight of a multiple-PAA audio core, MOPAD can serve well as a multi-PAA PAD.

Economy: Users desire low cost for the items that they purchase. MOPAD enables cost savings to the user through both modularization and support for multiple PAAs.
MOPAD's modularization increases economy to the user by allowing the separate purchase of the different components/modules. Because different modules have different typical lifetimes—and thus different purchasing schedules and pressures, separated purchasing increases economy. Examples: 1) The user may purchase an expensive, jeweled necklace mount for wear on formal occasions. This single piece of jewelry can be used for a number of years through multiple generations of audio core technology. 2) The user may purchase different mounts for different occasions and different days—just as the user may purchase different neckties for different days. Since the cost of the mount is separated from the cost of the audio core, the mount is manufactured, and thus sold, relatively inexpensively. 3) The user may purchase mounts for special conditions. E.g., A waterproof swimming mount combined with an audio IO set designed for underwater use can be used with the user's normal audio core. Such special condition mounts are relatively inexpensive since they do not include the audio core. 4) The user may replace a damaged component (e.g., wrist remote that had been stepped on) without having to replace the other modules at the same time.
MOPAD's support for multiple PAAs allows the user to buy a single device for all PAAs of interest, rather than a different device for each PAA. I.e., the user does not need to purchase a separate: mobile phone, cordless phone, audio broadcast receiver, music player, etc. While the price of the multi-PAA audio core is larger than the price of a single-PAA audio core, it is lower than the combined price of separate single-PAA PADs.

Adaptive Occupation: Designers of control components typically must tradeoff between capability and bulk. Because MOPAD allows the user to choose between different styles of remotes and even carry (and access) different remotes at the same time, it makes the capability/bulk tradeoff dynamic and puts it into the hands of the user. The user may carry a pocket remote, a wrist remote or both. If the user is carrying both pocket and wrist remotes, then for any given occasion, they can select the remote that is most convenient.
Activities well suited for a wrist remote include: glancing at the time, screening the ID of an incoming caller, pausing or fast forwarding a song, changing the audio volume, muting a phone call, and terminating a phone call.
Activities well suited for a pocket remote include: dialing a number for a phone call, configuring the MOPAD, sending an SMS message, playing a game, viewing a calendar entry, editing an address book, defining a music play list, and browsing a directory of audio files.
   5.7 Best Mode

MOPAD is designed largely around the recognition that there is no single best mode for PADs. Different situations are best served by different configurations. And even for the same situation, different users will prefer different configurations. That said, it is nonetheless possible, to describe general configurations which will be preferable for most users for specified situations.
Normal Mode: In most user stances (sitting, driving, standing, walking), the user is best served by a necklace or string tie mount, plus a wrist remote and a pocket remote. The necklace and string tie mounts (which are described in later sections), provide comfortable support for the audio core, and integrated audio IO with output in the form of earphones. The earphones, which may be draped or spooled from the back of the neck, can be easily and quickly inserted and removed, and can be configured as monophonic (e.g., for telephony) or stereophonic (e.g., for music). The wrist remote provides quick and easy access to the MOPAD's functions, while the pocket remote provides slower but more flexible access to the MOPAD's functions.
Exercise Mode: Exercise generally requires a mount that is more firmly attached to the body than the necklace or string tie mounts. (E.g., an arm-band or fanny-pack mount.) Audio IO is often best provided by a pair of behind the neck earphones, but can also be well provided by headphones or a pair of securely seated earphones. The connection between the audio IO set and the audio core may be wireless or by wire through the mount. A pocket remote is often too inconvenient to carry, but a sports style wrist remote works well.
Handset Telephony Mode: When the user wishes to use the MOPAD only for telephony (mobile or cordless), but does not wish to wear the MOPAD, or wishes to carry the MOPAD as a single unit, then the audio core can be mounted on a handset mount (described in a later section). The handset mount provides audio IO, visual display and manual controls, and, with the audio core seated in it, takes the form of a single, integrated device for simple carriage.
Undressed/Stationary Mode: When the user is undressed, or lightly dressed and is in a fixed location (e.g., at home, near bedtime), then the audio core can be mounted on a stationary mount (described in a later section). Like the handset mount, the stationary mount provides audio IO, visual display and manual controls, and, with the audio core seated in it, takes the form of a single, integrated device. The stationary mount also provides recharging for the audio core's batteries.

Aside from the configuration specific best modes described above, best modes can be recognized in regards to the PAAs supported. 1) Telephony is generally the most popular PAA, or at least, it is the single PAA that most users most desire continuous access to. Hence, having the audio core support mobile telephony is a best mode. 2) Multi-PAA audio cores are generally preferable to single-PAA audio cores. (However, the advantage of continual access to multiple PAAs must be weighed against the increased cost, size and weight that is associated with multi-PAA support.) Again, it should be remembered that a specific MOPAD is best configured when it is arranged to suit the desires of its owner.

### 6 DISCLOSURE: MODULE DETAILS

6.1 Audio Core

Construction: FIG. 12: The audio core encloses: an (optional) power source 106, the core electronic and digital components 107 of the supported PAAs, and the local wireless (Bluetooth or other) electronic and digital components 108. An on/off/standby switch 109 is provided in some embodiments. FIG. 13: The audio core is built with standardized dimensions, with slots 111 at the edges and an electrical connector 110 at the bottom. FIG. 14: These elements engage with corresponding rails 113 and electrical connector 114 of a receptacle 112 built into the mount. The audio core is secured in position on the mount by a locking mechanism 115.

6.2 Remote Controls

Remote controls are connected by wire or wirelessly to the audio core. Usually the connection is wireless, since this provides the greatest freedom of motion to the user. Remote controls vary in power and degree of independence from the audio core. At one extreme, they have relatively low powered CPUs, and act as little more than IO peripherals for the audio core (e.g., many wrist remotes). At the other extreme, they have powerful CPUs an can act as completely independent devices (e.g., a PDA carried by the user, or a desktop computer proximate to the user).

Attention signals (e.g., the ring of an incoming phone call) are often routed through the remote control. Signaling can take the form of a sound or a vibration.

6.3 Pocket Remote

Construction: One form of remote control is a pocket remote. FIG. 18: This device can be similar to the faceplate of a mobile phone, with keypad 119, and display 120 components. While the face dimensions are similar to those of a mobile phone handset, the pocket remote is lighter and thinner because it has less circuitry and smaller power requirements.

Objects and Advantages: The pocket remote provides a control for the MOPAD that is lightweight yet large enough to provide good control over the functionality of the MOPAD. It can be carried in the user's pocket, on the user's belt or in the user's purse, backpack or fanny pack. Because of its size, it affords one-handed operation.

6.4 Wrist Remote

Construction: The wrist remote is worn on the user's wrist like a wristwatch. While the wrist remote can be built with a keypad, many users may find this configuration to be bulky and unwieldy. FIG. 20: Another embodiment provides 2-6 buttons 121 at the edges of the unit and a display 123 as the face of the unit. In some embodiments, the electronic core and face of the device may be upgraded by replacement while keeping the original case.

Additional control for the wrist remote can be provided by a bezel ring control 122. In some embodiments, this is a rotatable ring, where the degree of rotation is used to control: number dialing, selection from a list, etc. In other embodiments, a series of small buttons or skin contact sensors arranged along the bezel ring are made to simulate the control of a mechanically rotatable bezel ring by sensing the movement of the user's finger tip along the bezel ring.

Objects and Advantages: The wrist remote allows short pieces of information (e.g., incoming caller ID, music track position) to be visually accessed, and control selections (e.g., accept or reject a call) to be made on the order of a second. While this speed and convenience are achieved at the cost of display and control size, users will often find this tradeoff acceptable.

Best mode: When a wrist remote is present, most users will find it to be the most convenient remote for attention signaling. It is close enough to be heard and/or felt, but not so close or loud as to be too startling when the user is busy. Moreover, since the wrist remote is usually the most visibly accessible device, it is also the most convenient for display of the accompanying attention message.

6.5 Audio IO Set

Construction: FIG. 22: The audio IO set provides sound in 124 and monophonic and/or stereophonic sound out 125 channels. The sound output device can take a variety of forms, including: earphones, headphones, neckphones, and external speakers. The sound input device (microphone) can be integrated with the sound output device or provided separately. Sound output devices worn over the ears can also provide feedback to the audio core indicating whether the sound output device is in place or not. Determination of in-placeness can be made by sensing: skin contact, echoes from the ear, or mechanical deformation of the output device.

6.6 Auxiliary Modules

FIG. 11: Auxiliary modules 105 (e.g., power sources, memory storage devices, AM/FM receivers, music players, and special frequency radio transceivers) enhance the abilities and capacities of the MOPAD. FIG. 15, FIG. 16: They are connected to the audio core wirelessly or by wire through the mount.

Objects and Advantages: The auxiliary modules enhance the abilities and capacities of the MOPAD at low cost because they do not need to be complete, stand alone devices. They also allow the weight carried by the user to be managed, since they can be added to and removed from the MOPAD according to the situation and the user's desires. I.e., if the user feels that the inconvenience of the auxiliary module's weight outweighs the benefit of its presence, then they can leave it behind.

### 7 DISCLOSURE: NECKLACE MOUNT

7.1 Construction

FIG. 23: The necklace mount is well defined by certain core characteristics: 1) It is worn around the neck. 2) The audio core receptacle 112 is positioned in front. 3) It provides an integrated audio IO set. Audio output is through of a pair of earphones 125 whose wires connect to the rest of the mount at the nape of the user's neck. Audio input is through a microphone 124, which may be integrated into the earphones or positioned separately at the front of the mount. 4) It supports auxiliary modules 105, e.g., batteries or memory modules. These auxiliary modules may be attached at or near the rear of the necklace mount where they can serve as counterweights to the weight of the audio core in front.

Necklace mounts can be varied stylistically by varying design, material and ornamentation just as normal necklaces are varied stylistically. As described in a previous section, the audio core may be revealed, hidden by the general design of the necklace mount, or covered by a faceplate 127. In some embodiments, the faceplate is made interchangeable in order to allow quick and easy stylistic variation.

Usually the length of the necklace is semi-fixed—i.e., it can only be changed (e.g., by adding or removing links) with special tools and by a prolonged effort (on the order of minutes). (This limitation on ease of length variation is in contrast to the easily varied length of the string tie mount, which is described in a later section.)

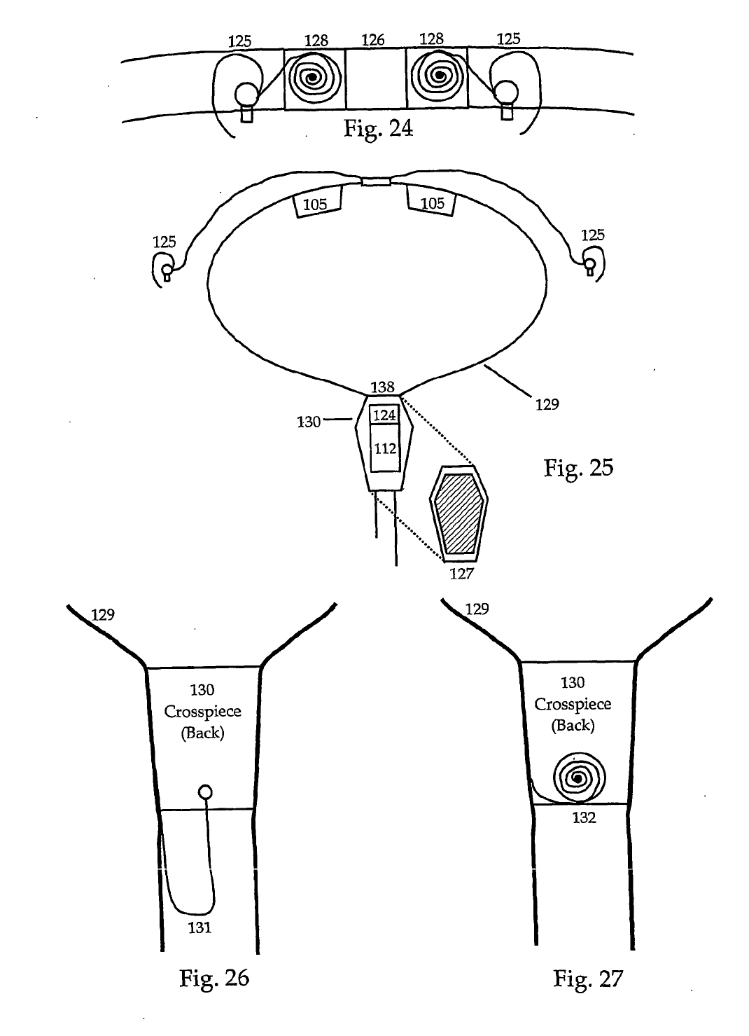

The wires to the earpieces of the earphones may be draped around the sides of the neck and possibly (loosely) attached to the front of the necklace mount. FIG. 24: Or they may stored at the back of the neck, with wire slack being taken up by spools 128. Or they may be draped down the back—though many users will only find this to be convenient while they are standing, walking or running.

7.2 Operation

Donning: The necklace mount is donned and removed in the same manner as normal necklaces. If the audio core is not already in place, then it can be inserted either before or after the necklace mount is donned.

Earphone Usage: Because of their position, the earphones can be quickly and easily inserted and removed. The user simply grabs the earphone and moves it a few inches to or from the ear.

7.3 Objects and Advantages

The necklace mount has a number of advantages over other mounts that combine to make it the preferred configuration for the MOPAD for many users in many situations.

Audio IO integration and proximity of the mount to the head (and thus to ears and mouth) provide many of the necklace mount's advantages. 1) Donning/removal of the MOPAD is simplified because it is not necessary to don/remove a separate audio IO set. 2) Only short wires are necessary (between the nape of neck and the earpieces), and these wires are in a location where they do no interfere with clothing or movement. 3) Earphones can be quickly and easily inserted or removed, thus simplifying access, and reducing audio encumbrance. 4) A single earphone can be inserted to provide monophonic sound or both earphones can be inserted to provide stereophonic sound (depending on the user's desires and the demands of the PAA). 5) Because a wire connection to the integrated audio IO is provided, it is not necessary to use a wireless audio IO channel. This: makes it easier to provide high quality sound, reduces power consumption, and conserves wireless bandwidth. Because wireless bandwidth is not used for audio IO, that bandwidth is available for other purposes (e.g., cordless telephony, and local person-to-person radio conversation).

The location and nature of the necklace mount encourages stylization, which makes the MOPAD attractive to users. Even men from cultures where men do not commonly wear jewelry may find the necklace mount acceptable, much as they have found wristwatches to be acceptable.

The location of the necklace mount provides an additional advantage in that it places the audio core in a position where it is less likely to collide with hard objects. (Consider in contrast an audio core carried on a belt or in a pants pocket.) Hence an audio core mounted on a necklace mount is less likely to be damaged by collisions.

### 8 DISCLOSURE: STRING TIE MOUNT

8.1 Construction

FIG. 25: String tie mounts are similar to necklace mounts, except that rather than being constructed around a semi-fixed length piece of jewelry or strap, they are built around a string or lanyard 129 whose ends dangle down loosely after being joined by a crosspiece 130. The crosspiece is arranged so that it can slide up and down the string ends and thus adjust the tightness of the string tie around the neck. Microphone 124, earphones 125 and auxiliary modules 105 are arranged in the same manner as they are on necklace mounts. The receptacle 112 for the audio core is integrated into the crosspiece. The receptacle and audio core are covered by a stylized faceplate 127. In some embodiments, the faceplate is made interchangeable in order to allow quick and easy stylistic variation.

The string is constructed from stylistically attractive and comfortable material (e.g., braided leather). It also includes an electrical wire to connect the audio core in the crosspiece with the earphones and auxiliary modules. Note that it is necessary to maintain an electrical connection between the crosspiece (which holds the audio core) and the string. This can be accomplished by fixing one end of the string to the crosspiece and allowing the other end to slide freely in the crosspiece. However, this embodiment has the undesired side-effect of causing the earphone connection to move away from the nape of the neck as the string neck loop size is varied. FIG. 26, FIG. 27: In two alternate embodiments, the crosspiece is allowed to move freely along both ends of the string, with the electrical connection being maintained through a free loop 131, and a spooling mechanism 132 in the respective embodiments.

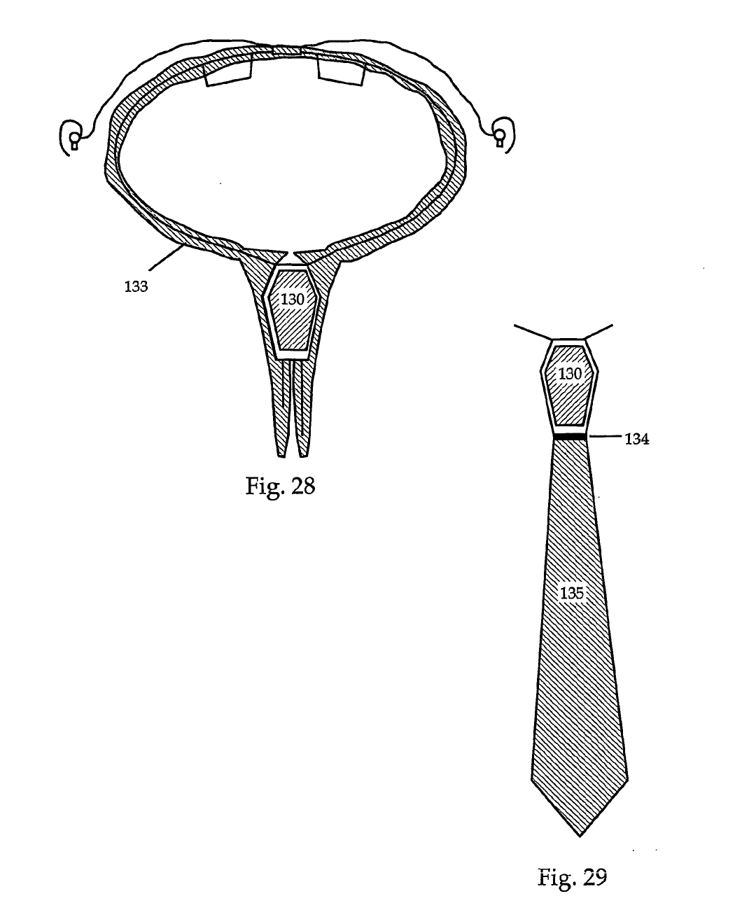

Additional elements may be added to the string tie so as to match existing stylistic norms.
Scarf Mount: FIG. 28: A scarf 133 is worn around the neck so that it obscures the string tie, but reveals the stylized crosspiece 130, to which it is clasped. Different scarves may be used with the same string tie.
Necktie Mount: FIG. 29: A flat, narrow slot 134 is added to the bottom of the crosspiece 130, and a necktie swath 135 is threaded through it and hung down in the normal fashion. The resulting arrangement has much the appearance of a normal necktie, but with the string tie crosspiece in the place of the knot. (Note that the necktie swath used must be shorter than the necktie swath for a normal necktie, since it is not knotted and does not loop around the neck.)
   8.2 Objects and Advantages

The string tie mount is essentially a stylistic variation on the necklace mount, and such it provides the same objects advantages as the necklace mount. However, it offers additional advantages beyond the necklace mount's advantages: 1) It offers an easy and quick length adjustment. This is convenient for moving from formal situations (which typically demand tighter neck attire), to casual situations (which allow looser neck attire). 2) It matches the existing stylistic norms of scarves and neckties, thus making the MOPAD more culturally acceptable. 3) It allows easy, rapid and inexpensive stylistic variation through exchange of varying: faceplates, scarves and necktie swaths.

### 9 DISCLOSURE: NECKLACE AND STRING TIE AUDIO IO SETS

9.1 Construction

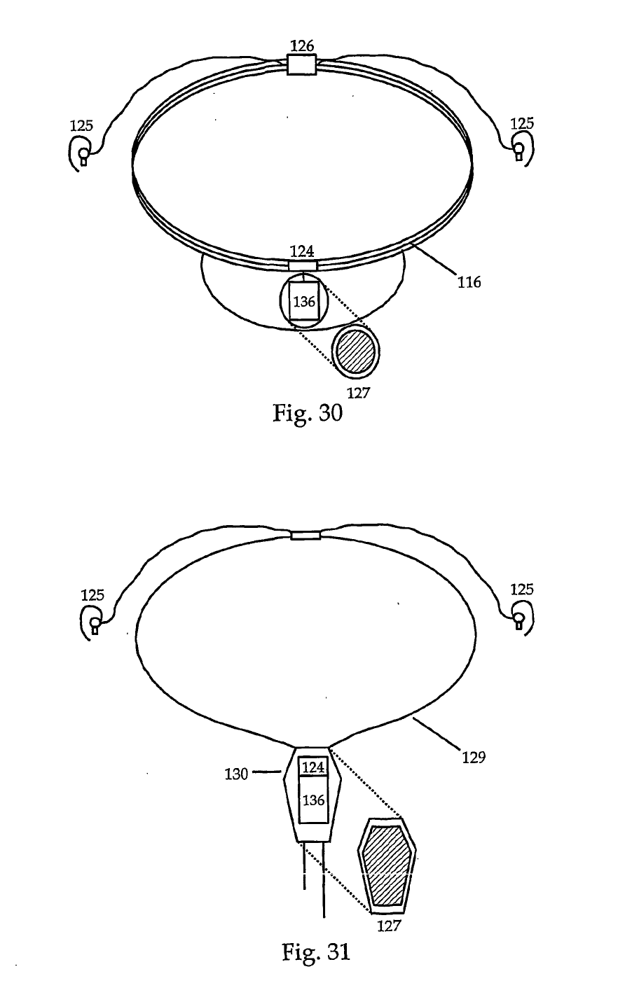

Some users will find it useful to separate the mount module from necklace and string tie mounts while retaining the audio IO arrangement. FIG. 30, FIG. 31: This is accomplished by replacing the receptacle with a wireless receiver module. In alternative an embodiment, a wire connection to a mount module (located elsewhere) is made in the place of the wireless connection.

9.2 Objects and Advantages

The necklace and string tie audio IO sets offer much the same audio IO advantages as the corresponding mounts, but are lighter and less bulky.

### 10 DISCLOSURE: OTHER WEARABLE MOUNTS

While neck mounts often provide the best mode for wearable mounts, other wearable mounts may be more advantageous for some users or for some situations.

10.1 Slip Mount

For the mounts described below, the receptacle and associated wires and auxiliary devices may either be integrated into the mount, or provided by a separate “slip mount” which is added to the larger mount (e.g., by slipping it into a pocket on the larger mount).
Note: If the audio core is self powered and is operated without wired connections, then even a slip mount is unnecessary. The audio core itself can be slipped directly into a pocket on the larger mount.

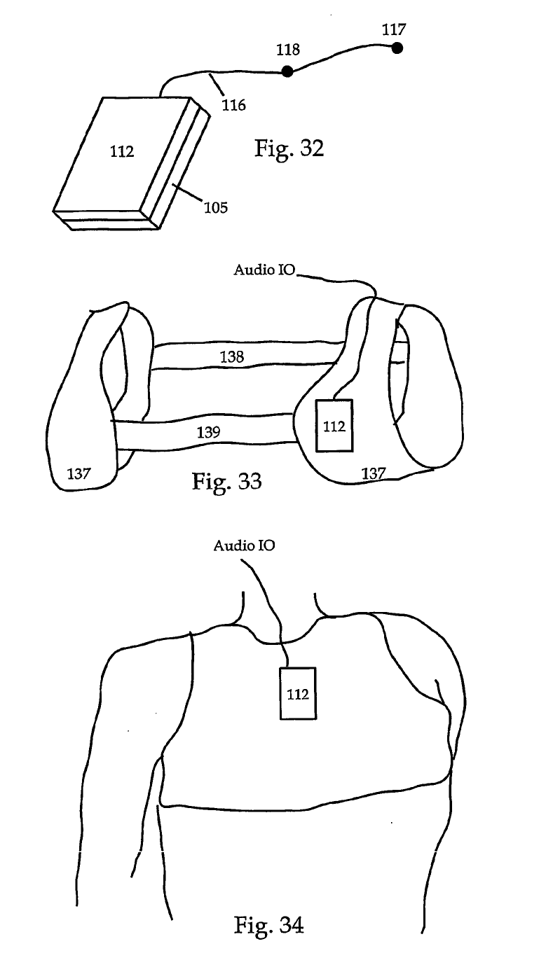

Construction: FIG. 32: The slip mount is little more than a bare receptacle 112 plus associated wires 116 and connectors 117, 118. In some embodiments, an auxiliary module 105 is included.

Objects and Advantages: The slip mount has several advantages over direct integration. 1) It reduces the cost of the larger mount. 2) It allows the larger mount to be washed without danger of damaging the electrical components of the mount.

10.2 Shoulder Fore Mounts

Construction: Shoulder fore mounts vary substantially, but the basic form is similar to that of a shoulder holster for a gun. FIG. 33: Loops of fabric 137 or other material encircle each shoulder, and are joined to each other by a stabilizing back strap 138. An additional stabilizing chest strap 139 is provided in some embodiments. The audio core receptacle 112 is placed on the front of one of the shoulder loops. For across the body balance, the opposite shoulder strap may carry a counterweight in the same position. This counterweight may be an inert weight, an auxiliary module, or personal effects (e.g., wallet). For fore to back balance, additional counterweights may be added to the back of the mount.

Variations: The shape of the shoulder mount can be varied substantially, taking on forms such as: bra, halter and vest.

Objects and Advantages: The shoulder fore mount has several advantages: 1) Compared to the neck mount, the shoulder fore mount may allow comfortable carriage of greater weight. 2) It leaves the front-central part of the chest bare, which may be stylistically desirable. 3) It provides stylistic variation. It may be hidden under clothing, or stylized and displayed prominently.

10.3 Shoulder Rear Mounts

Construction: FIG. 34: Shoulder rear mounts are constructed similarly to shoulder fore mounts, except that the audio core 112 is placed centrally on the back between the shoulder blades.

Variations: Similar to the variations for the shoulder fore mount.

Objects and Advantages: The shoulder rear mount provides fairly stable and secure positioning for the audio core, which is advantageous for some activities (e.g., walking, running, sitting).

10.4 Armband Mount

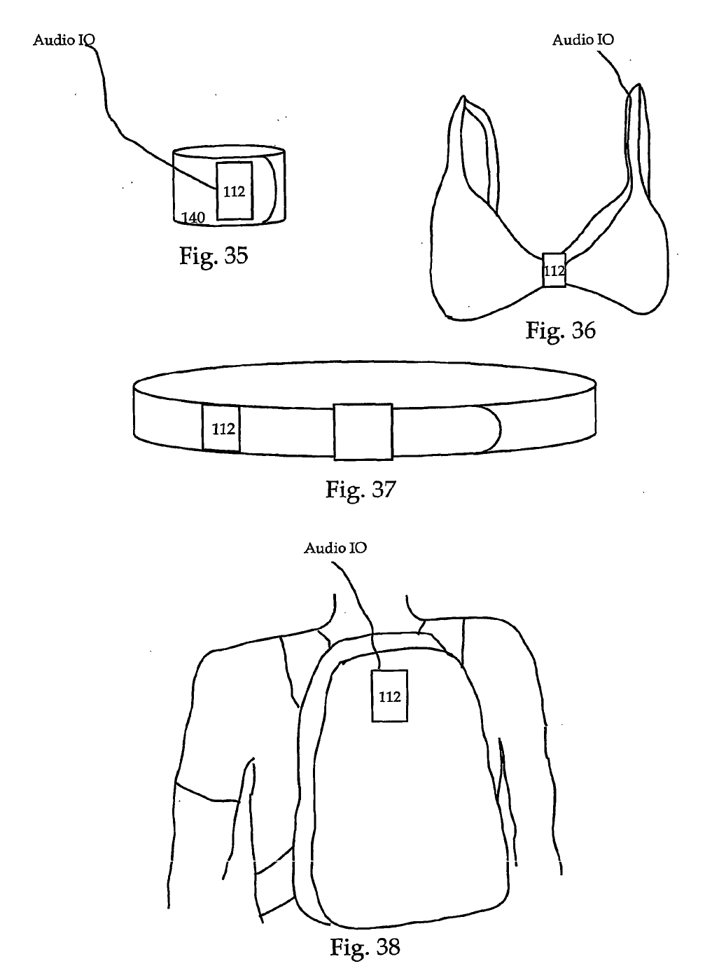

Construction: FIG. 35: Armband mounts takes the form of an armband 140 strapped around the upper arm. Connection to audio IO may be wired or wireless.

Objects and Advantages: The armband mount provides fairly secure placement for the audio core, while not subjecting it to excessive movement, and not requiring an excessively long wire for connection to the audio IO set. It is best suited to casual situations in which the arm is bare, and in which weartime is restricted to an hour or so (e.g., running, and weight lifting).

10.5 Bra Center Mount

Construction: FIG. 36: Bra center mounts are similar to shoulder mounts except that the receptacle is located between the breasts.

Objects and Advantages: The bra center mount incorporates the mount into an existing item of clothing, and hence removes the need for an additional article of attire. Also, like the shoulder mount, the bra center mount leaves the front of the chest clear.

10.6 Belt Mount

Construction: FIG. 37: Belt mounts put the receptacle and associated devices and connections on the user's belt.

Objects and Advantages: The belt mount allows comfortable carriage of the weight of the audio core.

10.7 Bag Mounts

Construction: FIG. 38: Bag mounts support the audio core in a bag (e.g., backpack, fanny-pack, purse).

Objects and Advantages: The bag mount may be convenient for users who would carrying the bag regardless of the presence of the MOPAD.

### 11 DISCLOSURE: HANDSET MOUNT

11.1 Construction

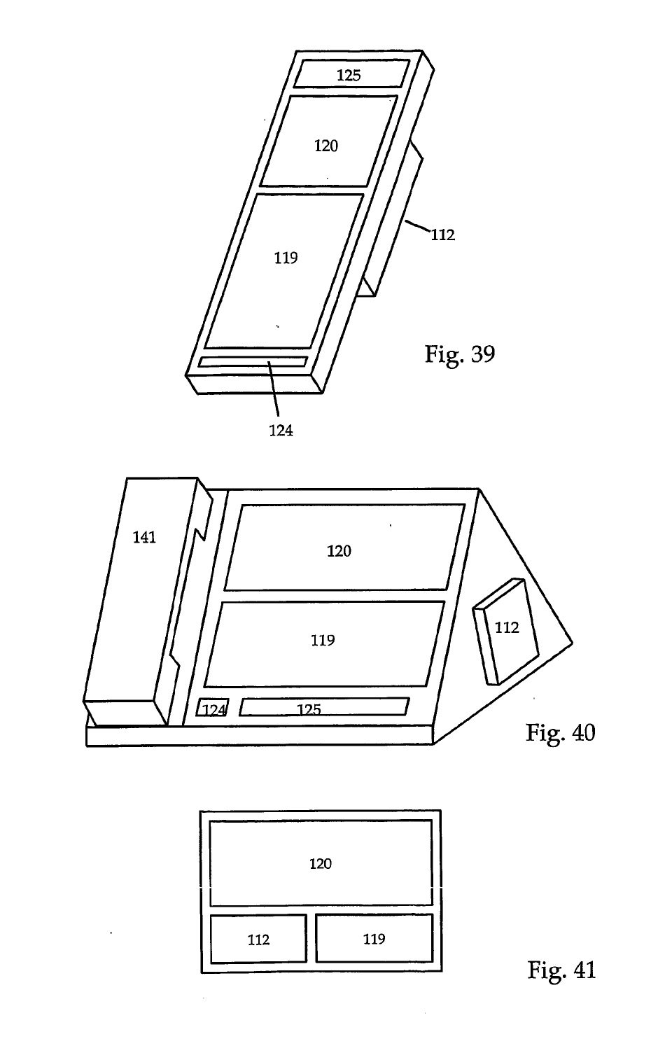

FIG. 39: The mount takes the form of mobile phone handset, thus combining the functions of mount, remote control and audio IO. In some embodiments, the handset is able to connect wirelessly with the audio core.

11.2 Operation

The combined device is carried and operated like a normal mobile phone handset.

11.3 Objects and Advantages

1) Allows the user to carry the MOPAD as a single unit, and does not require the user to wear the device. This is convenient when the user wishes to keep the device near them, but does not expect to use the device frequently or intensively. 2) Does not require a personal area wireless network when used as a mount (since all modules are directly connected). Thus the danger of radio interference with the personal wireless network is removed.

### 12 DISCLOSURE: STATIONARY MOUNT

12.1 Construction

FIG. 40: The stationary mount takes the form of a stationary, tabletop device, with integrated display 120, controls 119, and audio IO. Audio IO takes the form of a microphone 124 and speakers 125 built into the unit. In some embodiments, audio IO is also or alternatively provided through an attached handset 141. Power is supplied by an external power source (e.g., the electrical grid), or by an internal battery. When external power is available, the mount can also act to recharge the batteries of mobile pieces of the MOPAD (e.g., audio core, remote controls).

FIG. 41: An alternative embodiment is to build the stationary mount into a vehicle (e.g., an automobile), where it either augments or takes the place of the vehicle's built-in sound system.

12.2 Operation

Depending on its design emphasis, the combined device may be handled like a: corded telephone, speaker phone, car phone, or music player.

12.3 Objects and Advantages

The stationary mount converts the MOPAD to stationary use and provides battery recharging.

12.4 Best Mode

Stationary mounts will most often be deployed as a home base for the user's MOPAD. Many users will find it most useful when placed near their bed or at some other easily accessed location in the home. The user may move the audio core to the stationary mount while retiring for the night and retrieve it in the morning before going out.

Users who are stationary for long periods of time (e.g., while working at a desk or driving a vehicle) and who prefer not to wear their MOPAD, may prefer to use this mount.

### 13 DISCLOSURE: MOPID

While the system described to this point has focussed entirely on PAAs, many non-audio applications are also well supported by MOPAD. One category of applications that may be readily made available on a MOPAD is that of applications currently available on mobile telephones. This set of applications is quite large, including: text messaging, games, email, and web browsing. Another category of non-audio applications that may be made available on a MOPAD is that of applications currently available on palm or pocket computing devices. This set of applications is also quite large, including: address book, calendar, task list, expense tracking, and ebook display.

MOPAD embodiments which support a substantial number of non-audio applications might be better called MOPIDs (Modular Personal Information Devices).

### 14 BEST MODE

Note that best mode for various components and configurations has been presented in preceding disclosure sections and subsections.

### 15 ALTERNATIVE EMBODIMENTS AND VARIATIONS

The embodiments and variations of the MOPAD system described here are illustrative, but not exhaustive. Many additional embodiments and variations will be apparent to those skilled in the art. Among the aspects which may be readily varied are: 1) alternative audio core to receptacle mounting systems, 2) alternative wireless networking systems, 3) alternative remote controls, 4) alternative audio IO devices/systems, 5) alternative mounts, and 6) alternative embodiments of described mounts.

1. An audiocore module for a modular personal audio device, comprising:
a set of electronic components able to provide the core functionality of one or more personal audio applications,
a first means for securely mounting said audiocore module on a mount module that allows said audiocore module to be quickly and easily mounted on or unmounted from said mount module by a user,
a first electrical connector which will mate with a corresponding electrical connector on said mount module when said audiocore module is mounted, and which is able to communicate audio and control information between said audiocore module and other external modules,
whereby said audiocore module is able to provide the core functionality for said modular personal audio device,
whereby said modular personal audio device can be rapidly reconfigured by said user in order to adapt to the requirements of said user's current stance, situation and stylistic desires.

2. The audiocore module of claim 1, wherein said audiocore module is able to be mounted on a necklace mount module.

3. The audiocore module of claim 1, wherein said set of electronic components provide the function of mobile telephony.

4. The audiocore module of claim 1, wherein said set of electronic components provide the function of playback of recorded audio-files.

5. An mount module for a modular personal audio device, comprising:
a base structure on which the other elements are arranged, and which is designed to provide a useful base form for a user's current stance, situation and stylistic desires,
a receptacle which securely holds an audiocore module, and which allows said audiocore module to be easily mounted on or unmounted from said mount module by said user,
a first electrical connector which will mate with a corresponding electrical connector on said audiocore module when said audiocore module is mounted,
a set of electrical wires which connects to said first electrical connector, which allows communication of audio and control information,
whereby said mount module provides a basic physical structure for said modular personal audio device,
whereby said modular personal audio device can be rapidly reconfigured by said user in order to adapt to the requirements of said user's current stance, situation and stylistic desires.

6. The mount module of claim 5, wherein said base structure is wearable, whereby said modular personal audio device can be carried and used in a predominantly hands-free manner.

7. The mount module of claim 6, wherein said base structure is designed to be worn on the upper body of said user, whereby a wire connection to an audio input-output unit may be kept relatively short.

8. The mount module of claim 7, wherein said base structure has the form of a necklace, and which allows a microphone to be placed near the throat, and allows a set of earphones to be attached at the nape of the neck, whereby the weight of said mount module and said audiocore module can be easily supported by said user, and whereby said set of earphones can be stored in an unobtrusive and easy to access location.

9. The mount module of claim 7, wherein said base structure has the form of a string tie, and which allows a microphone to be placed near the throat, and which allows a set of earphones to be attached at the nape of the neck, whereby the weight of said mount module and said audiocore module can be easily supported by said user, and whereby said set of earphones can be stored in an unobtrusive and easy to access location.

10. The mount module of claim 7, wherein said base structure takes the form of a vest.

11. The mount module of claim 7, wherein said base structure takes the form of an armband.

12. The mount module of claim 5, wherein said base structure is minimal, and is designed to slide into pocket on an item of clothing in a way that allows said item of clothing to act as a wearable mount.

13. The mount module of claim 5, wherein said base structure has the form of a mobile phone handset, and further including: a display, a set of controls, an audio input-output set, whereby said mount module adapts said modular personal audio device to a form factor that may be readily carried on said user's person as a single unit.

14. The mount module of claim 5, wherein said base structure has the form of a stationary, off-person device, and further including: a display, a set of controls, an audio input-output set, whereby said mount module adapts said modular personal audio device to situations where said user is in a relatively fixed location and cannot or does not want to wear said modular personal audio device.

15. A method of adapting a personal audio device to a user's varying stance, and stylistic and functional needs, comprising the steps of:
providing a plurality of audio core modules, which enclose the core electronic components required to support one or more personal audio applications, where different audio core modules provide different personal audio applications or different combinations of personal audio applications,
providing a plurality of mount modules, which allow said audio core modules to be securely held, and which provide wired electrical connections between said audio core modules and other modules, where different mount modules are designed to provide stylistic variation, or to be worn or carried in different ways by said user,
providing a plurality of audio input-output modules, which may be connected by wire or wirelessly to said audio core modules, where different audio input-output modules are designed to provide stylistic variation, or to be worn or carried in different ways by said user,
providing a plurality of remote control modules, which provide audio and visual control of the functions of said audio core modules, and which may be connected by wire or wirelessly to said audio core modules, where different remote control modules are designed to provide stylistic variation, or to be worn or carried in different ways by said user, or to provide different degrees of control over and display of the functions of said audio core modules,
providing a plurality of integrated modules, which combine the functions of mount modules, audio input-output modules, and remote control modules,
selecting an audio core module, and an integrated module, or a mount module, an audio input-output module and one or more remote control modules, so that when combined, the selected modules will form a complete personal audio device, and will be well adapted to the requirements of said user's current stance, situation and stylistic desires,
combining the selected modules.

16. The method of claim 15, wherein said plurality of audio core includes modules that provide the function of mobile telephony.

17. The method of claim 15, wherein said plurality of audio core includes modules that provide the function of playback of recorded audio-files.

18. The method of claim 15, wherein said plurality of mount modules includes mounts configured as necklace mounts, string tie mounts, slip mounts, armband mounts, handset mounts, and stationary mounts.
